(19) United States
(12) Patent Application Publication
(10) Pub. No.: US 2010/0180740 A1
(43) Pub. Date: Jul. 22, 2010

(54) MACHINE TOOL HAVING A SAFETY UNIT AND A CALIBRATION UNIT FOR CALIBRATING THE SAFETY UNIT

(76) Inventors: Reiner Krapf, Reutlingen (DE); Heiko Braun, Leinfelden-Echterdingen (DE); Wolfgang Baierl, Remshalden (DE); Michael Mahler, Leinfelden-Echterdingen (DE); Alexander Werner Hees, Bietigheim-Bissingen (DE)

Correspondence Address: KENYON & KENYON LLP, ONE BROADWAY, NEW YORK, NY, 10004, US

(21) Appl. No.: 12/452,550

(22) PCT Filed: May 13, 2008
(86) PCT No.: PCT/EP2008/055837

§ 371 Date: Mar. 29, 2010

(30) Foreign Application Priority Data
Jul. 11, 2007 (DE) 10 2007 032 221.8

(51) Int. Cl. B23Q 11/00; F16P 3/14

(52) U.S. Cl. 83/72; 83/76.1

(57) ABSTRACT

A machine tool having a safety unit. The machine tool also having a calibration unit for calibrating the safety unit.

### FIELD OF THE INVENTION

The present invention is based on a machine tool having a safety unit. The present invention is further based on a method regarding a machine tool.

### BACKGROUND INFORMATION

A circular-saw bench having a safety device is known. The safety device is provided with a sensor unit and is used to monitor a danger zone in the immediate surrounding area of a saw blade with the aid of the sensor unit.

### SUMMARY OF THE INVENTION

The exemplary embodiments and/or exemplary methods of the present invention is based on a machine tool having a safety unit.

It is provided that the machine tool have a calibration unit for calibrating the safety unit.

The safety unit may thereby be adapted advantageously to a work environment when using the machine tool. In particular, the safety unit has a sensor unit and an actuator unit, which is provided to trigger a safety procedure as a function of a characteristic quantity detected by the sensor unit. False trippings of the actuator unit based on a work environment altered relative to a factory setting or an earlier use of the machine tool may be avoided particularly advantageously due to the calibration unit. This altered work environment may be characterized by a changed ambient parameter such as temperature, moisture, in-house network impedance and/or by changed clothing of a do-it-yourselfer or craftsman. A “calibration” of the safety unit is to be understood in particular as a procedure in which a reference value is determined for at least one characteristic quantity detectable by the safety unit, especially by the sensor unit. In particular, this reference value may take the form of a threshold value of the characteristic quantity, above or below which an operation is triggered with the actuator unit. The calibration expediently represents a procedure which takes place prior to a tool of the machine tool being driven, and which may work with an actuator unit decoupled from a sensor unit of the safety unit.

In one development of the exemplary embodiments and/or exemplary methods of the present invention, the machine tool has an operator control unit which, in interaction with the calibration unit, is provided for a calibration procedure by an end operator. In this context, an “operator control unit” is to be understood particularly as a unit which is provided to produce a circulation of information between the machine tool and an end operator of the machine tool. To that end, the operator control unit may have at least one output unit for the output of information. An operator control unit which is provided “for” a calibration procedure is to be understood in particular as an operator control unit which is utilized in at least one calibration mode of the calibration unit. In this connection, the calibration unit has one calibration mode in particular, in which a calibration procedure draws upon an operation with the operator control unit, such as an output and/or an input. An “end operator” in this connection is to be understood in particular as a do-it-yourselfer and/or a craftsman who acquires the machine tool for private or commercial purposes. Advantageously, the calibration unit, in interaction with the operator control unit, is used to modify calibration data of a factory calibration performed in a factory during the assembly of the machine tool and/or calibration data of a previous use of the machine tool.

The calibration unit may have a checking unit, which is provided to check a calibration status of the safety unit. Ease of operation may be increased advantageously in this manner. In particular, the existence of a calibration adapted to a work environment may be recognized, thereby making it possible to avoid an unnecessary calibration procedure. A “calibration status” in this context is to be understood in particular as the existence of calibration data, especially as in a stored form. These calibration data may correspond in particular to at least one reference value for at least one characteristic quantity able to be sensed by the safety unit. Furthermore, the calibration data may correspond to a characteristic quantity which is used to characterize a specific work environment like, for example, a characteristic temperature quantity, a characteristic moisture quantity, a quantity characterizing an electrical, magnetic and/or electromagnetic field, etc. A “check” of a calibration status is to be understood especially as a check of calibration data. In particular, by this may be understood a procedure in which existing calibration data are compared to at least one characteristic quantity sensed by the safety unit in a present work environment.

In this connection, great ease of operation may be achieved if the checking unit has at least one automatic checking mode. In this context, the checking unit may be provided to check the calibration status automatically upon start-up of the machine tool like, for example, upon application of voltage to the machine tool.

In addition, it is provided that the safety unit have a sensor unit for sensing a characteristic quantity during a driving of the tool, and the checking unit is provided in order, in a checking mode, to trigger a sensing operation of the sensor unit prior to the tool being driven. Advantageously, it is thereby possible to save on component parts, because a sensor unit which is provided to monitor a danger zone while the tool is being driven, is additionally used to ascertain a change in a work environment in the run-up to the driving of the tool. In this connection, “tool driving” is to be understood particularly as an operating mode of the machine tool in which a tool of the machine tool provided for processing a workpiece is driven by a drive unit like, for example, by an electric motor, into a movement such as a rotation, a pendulum movement, a back-and-forth movement, etc.

An especially safe use of the machine tool may be achieved if the machine tool has a control unit which is provided to control a driving of the tool and which, in at least one operating mode, requires a check of the calibration status in order to start the tool driving.

A calibration status of the safety unit may be checked rapidly and reliably if the machine tool has a memory unit and a control unit which, in interaction with the memory unit, is provided to store calibration data.

In a further embodiment variant of the present invention, the machine tool has an output unit and a control unit which, in interaction with the output unit, is provided to output information as a function of a calibration status of the safety unit, thereby making it possible to further increase the ease of operation. The output unit may be provided for a visual, acoustic and/or haptic output.

The exemplary embodiments and/or exemplary methods of the present invention is further based on a method regarding a machine tool which has a safety unit.

It is provided that a calibration status of the safety unit is checked after a start-up of the machine tool by an end operator, which means the ease of use and the application safety of the machine tool may be increased advantageously.

An especially high level of safety may be achieved if the check is required in order for the drive unit of the machine tool to start driving the tool.

It is further provided to calibrate the safety unit with the aid of a reference object which takes the form of a machine-tool accessory, thereby permitting an especially easy calibration. A “machine-tool accessory” is to be understood in particular as an object which is designed to be separate or detachable from the machine tool, and is manipulable by an end operator to perform the calibration.

Further advantages are derived from the following description of the drawing. The drawing shows an exemplary embodiment of the present invention. The drawing, the specification and the claims contain numerous features in combination. One skilled in the art will advantageously examine the features individually, as well, and combine them to form further useful combinations.

### BRIEF DESCRIPTION OF THE DRAWINGS

FIG. 1 shows a hedge trimmer having a sensor unit in a side view.

FIG. 2 shows a safety device of the hedge trimmer having a calibration unit.

FIG. 3 shows a flow chart describing a use of the hedge trimmer.

FIG. 4 shows one calibration mode of the calibration unit.

FIG. 5 shows a further calibration mode using an accessory of the hedge trimmer.

### DETAILED DESCRIPTION

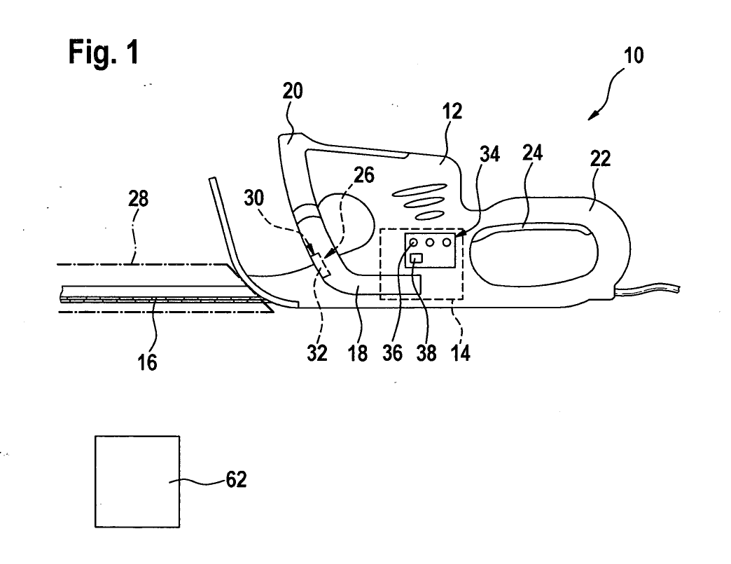

FIG. 1 shows a machine tool 10 taking the form of a hedge trimmer, in a side view. It has a housing 12 in which a drive unit 14 in the form of an electric motor is disposed. Drive unit 14 is provided to drive a tool, during which a tool 16, configured as a trimmer, is driven to move relative to housing 12. Machine tool 10 also has a first front grip 18, in which a first switching element 20, able to be manipulated by an operator, is recessably supported. In addition, a second rear grip 22 is provided, in which a second switching element 24, able to be manipulated by an operator, is recessably disposed. Switching elements 20, 24 are provided for starting and stopping drive unit 14. In this context, in known manner, driving of a tool by drive unit 14 is triggered exclusively by the simultaneous actuation of both switching elements 20, 24.

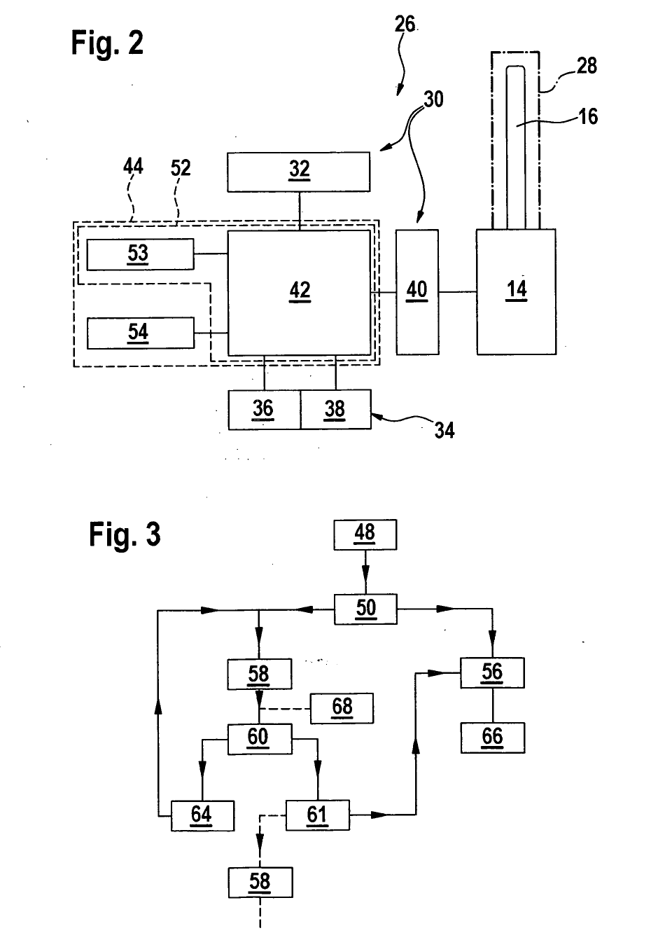

Machine tool 10 is further provided with a machine-tool safety device 26. It has a safety unit 30, which is used to monitor a danger zone 28 in the immediate vicinity of tool 16. To that end, safety unit 30 has a sensor unit 32. Safety unit 30 is shown in greater detail in FIG. 2. Sensor unit 32 is implemented by way of example as a capacitive sensor. Further forms of sensor unit 32 like, for example, an inductive sensor, UWB (ultra wideband) sensor, infrared sensor, video monitoring and/or further sensor designs appearing useful to one skilled in the art are conceivable. In addition, in a further implementation, it is conceivable that sensor unit 32 is provided for sensing a characteristic quantity with the aid of a transmitted sensing signal. In this case, sensor unit 32 may have two functional components, especially a transmitting element and a receiving element, which, for example, are disposed in a grip 18, 22, respectively. Machine-tool safety device 26 also has an operator control unit 34, whose method of functioning is described in greater detail below. It has an optical output unit 36 having a set of LEDs and an input unit 38 having a control button.

Machine-tool safety device 26 of machine tool 10 is shown in greater detail in a schematic representation in FIG. 2. Drive unit 14 and tool 16 may also be seen in FIG. 2. As described above, machine-tool safety device 26 has safety unit 30, which includes sensor unit 32 shown in FIG. 1. Safety unit 30 further has an actuator unit 40. In the example considered, actuator unit 40 is used to alter a tool-driving parameter of a tool driving implemented by drive unit 14 as a function of a characteristic quantity detected by sensor unit 32. To that end, actuator unit 40 is in operative connection with drive unit 14. In particular, actuator unit 40 is used to stop a tool from operating when the presence of a human body part is detected in danger zone 28.

In the exemplary embodiment discussed, machine tool 10 is implemented as a manual machine tool. A construction of machine tool 10 as a stationary device such as a table saw, cross-cutting and miter saw, etc., is likewise conceivable. If, in a further embodiment, machine tool 10 is implemented as a stationary device, actuator unit 40 may be used to activate a disabling arrangement to disable a movable tool bearing unit such as a retraction arm in the case of a miter saw.

In addition, machine-tool safety device 26 has a control unit 42 which is an operative connection with sensor unit 32, actuator unit 40 and operator control unit 34. Control unit 42 has an evaluating arrangement which is provided to evaluate a characteristic quantity sensed by sensor unit 32, and which is used in particular to control actuator unit 40 based on an evaluation process. Control unit 42 may have a microprocessor or a microcontroller, or may take the form of a microprocessor or microcontroller.

Machine-tool safety device 26 further has a calibration unit 44 which is used to calibrate safety unit 30.

Safety unit 30 is calibrated in the factory during assembly of machine tool 10. In so doing, threshold values of characteristic quantities which are detectable by sensor unit 32 are defined. If a threshold value is reached during a driving of the tool and upon the evaluation of a detected characteristic quantity, then control unit 42 transmits a control signal to actuator unit 40, which undertakes safety measures. During use of machine tool 10, a work environment may differ from an environment present during the factory calibration. Because of the altered work environment, false trippings of actuator unit 40 may thereby impair a work operation with machine tool 10. Calibration unit 44 is advantageously provided to modify calibration data of a factory calibration or of a previous use of machine tool 10 with the aid of a control action by an end operator.

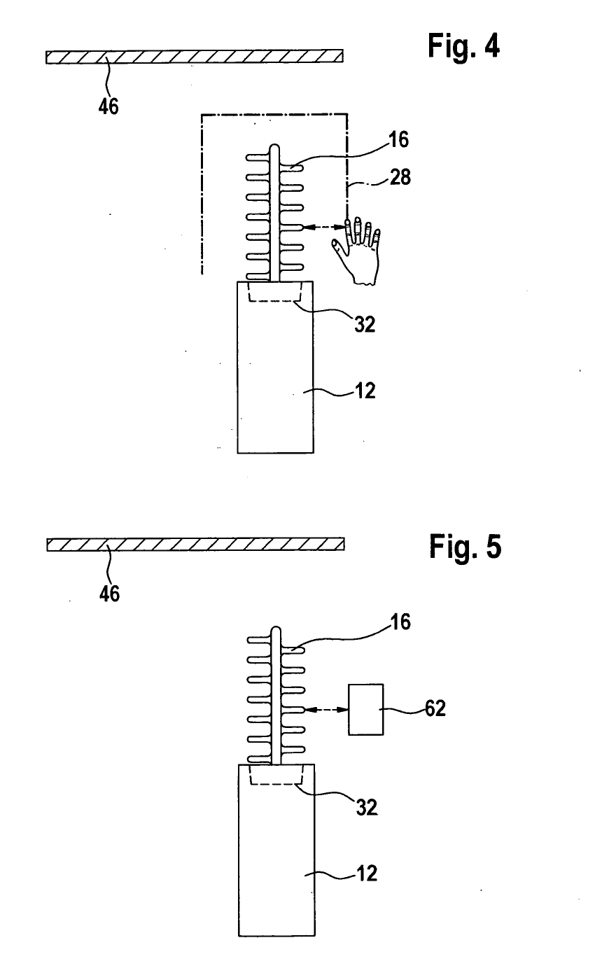

A practical application of machine tool 10 is described in greater detail with reference to a flow chart in FIG. 3. In addition, the following description relates to FIGS. 2, 4 and 5. FIGS. 4 and 5 show machine tool 10 in a schematic view. It is being used in a work environment in which an interference object 46 is located.

It is assumed that in a step 48, an operator puts machine tool 10 into operation by connecting it to a mains current supply. In a next step 50, it is checked whether existing calibration data for a machining using machine tool 10 are adapted to the work environment shown in FIG. 4. To that end, as can be seen in FIG. 2, calibration unit 44 has a checking unit 52 which is provided to check a calibration status of safety unit 30 characterized by the calibration data. In the example being discussed, control unit 42 is configured as a component of calibration unit 44 and of checking unit 52. In further embodiment variants, it is conceivable for calibration unit 44 to be separate from control unit 42 and, for example, to have a microprocessor different from control unit 42. Checking unit 52 has a memory unit 53 in which a program for realizing a checking mode is stored. In checking the calibration status of safety unit 30, checking unit 52 triggers a sensing operation of sensor unit 32, during which at least one characteristic quantity is sensed. This characteristic quantity or a quantity evaluated by an evaluation arrangement of control unit 42 based on the characteristic quantity is subsequently compared to existing calibration data which are stored in a memory unit 54 of calibration unit 44 shown in FIG. 2. These calibration data like, for example, threshold values for triggering actuator unit 40, correspond to a factory calibration or a calibration carried out in the case of a previous operation of the machine tool prior to the start-up in step 48.

The checking mode of checking unit 52 described here is an automatic mode, which takes place automatically after machine tool 10 is put into operation by an end operator. In a further embodiment variant, it is conceivable that a check may be carried out upon selection by the operator. In the run-up to and during the checking operation, actuator unit 40 prevents a start of tool driving by switching elements 20, 24. As can be gathered from the flow chart, control unit 42 requires a checking operation to start the driving of the tool.

In the example considered, a sensing operation of sensor unit 32 is triggered for the checking, the sensor unit likewise being used to monitor danger zone 28 while the tool is being driven. In an embodiment variant, it is conceivable for machine-tool safety device 26 to have a sensor device which is in addition to sensor unit 32 and which is called up in the event of a checking operation by checking unit 52. Sensor unit 32 and/or an additional sensor device is/are able to sense characteristic quantities which are a function of the work environment such as a characteristic temperature quantity, a characteristic moisture quantity, a characteristic impedance quantity, etc. If sensor unit 32 is provided for sensing with the aid of a transmitted sensing signal, a correlation may occur between the sensing signal in its received form and the sensing signal in its transmitted form like, for example, by an evaluation of the level of the received sensing signal.

If the existing calibration status is regarded by checking unit 52 as suitable for the work environment present in FIG. 4, in that no substantial deviation is determined between characteristic quantities detected within the current work environment and the stored calibration data, then in a step 56, actuator unit 40 enables drive unit 14 for a start-up with the aid of switching elements 20, 24. If the instantaneous work environment deviates from the work environment in which the previous calibration of safety unit 30 was performed, then in a step 58, the operator is informed that a calibration procedure is to be carried out. This is accomplished with the aid of output unit 36 and control unit 42. In so doing, output unit 36 is controlled by control unit 42 for the output of information as a function of a calibration status.

A first calibration mode is shown in FIG. 4. In this case, the operator places one hand in the vicinity of tool 16, and specifically, with a hand-to-tool distance of his/her choice, and remains in this position during a specific time span, while in a step 60, a sensing operation of sensor unit 32 is triggered. At least one characteristic quantity is detected during the sensing operation. This characteristic quantity or a quantity ascertained on the basis of this characteristic quantity is stored by calibration unit 44, and specifically, in particular by its control unit 42, in memory unit 54 as a threshold value for the triggering of actuator unit 40. The dimension of danger zone 28 is redefined by the choice of the hand-to-tool distance. Moreover, characteristic quantities which differ from threshold values and which are used for characterizing the instantaneous work environment and for a check when next starting up machine tool 10 may be stored in memory unit 54.

If the calibration procedure is accomplished, the operator is informed in a step 61 by output unit 36. If the calibration procedure has failed, then in a step 64, the operator is prompted by output unit 36 to repeat the calibration procedure.

After success of the first calibration procedure, further calibration procedures may be carried out. This is illustrated in FIG. 3 by a broken line going out from step 61.

A further calibration mode of calibration unit 44 provides that the operator carry out a calibration in a typical work position of machine tool 10 relative to an object to be processed. In this case, machine tool 10 is brought to the object to be processed like, for example, a hedge to be cut and is retained in a proper holding position by the operator. A further calibration mode may also be provided, in which tool 16 is brought into the vicinity of interference object 46.

In another calibration mode, the operator is prompted to carry out a calibration procedure with the aid of a reference object 62. Reference object 62 is a machine-tool accessory, which is supplied together with machine tool 10 (see also FIG. 1). To perform the calibration, reference object 62 is placed in the vicinity of tool 16. Various reference objects 62 may be provided, which in each case are produced from a different material. In particular, one reference object 62 may be assigned in each instance to a typical interference object.

Additional typical danger situations may be simulated in further calibration modes of machine tool 10. In particular, safety unit 30 may be calibrated when an electric cable for supplying machine tool 10 is placed in the vicinity of tool 16.

After the recalibration is accomplished, in step 56, actuator unit 40 enables drive unit 14 to start driving the tool. This tool driving may be triggered by the actuation of switching elements 20, 24 in a step 66.

A sensing operation of sensor unit 32 may be triggered automatically in step 60. Advantageously, however, after notification of the operator in step 58, calibration unit 44 is in a waiting mode, the sensing operation being able to be triggered with the aid of an actuation process by the operator. This may be carried out in a step 68, in which the operator actuates input unit 38. Alternatively, the operator may trigger the sensing operation in step 68 by actuating one of switching elements 20, 24.

The various calibration modes as well as the notifications associated with a calibration procedure may be identified by a coding of output unit 36 such as a color coding with the aid of colored LEDs. In a further embodiment variant, it is conceivable to provide operator control unit 34 with an acoustic output unit, the calibration modes and notifications being denoted by a tone coding and/or a voice message.

In another embodiment variant, it is further conceivable that memory unit 54, in interaction with control unit 42, is provided for storing calibration data which are assigned to at least two different work environments. If machine tool 10 is employed in alternation at two different places of use, after selection by the operator, the calibration data adapted to the respective work environment may be utilized without having to perform a calibration again in each instance.

1-11. (canceled)

12. A machine tool, comprising:
a safety unit; and
a calibration unit to calibrate the safety unit.

13. The machine tool of claim 12, further comprising:
an operator control unit, which, interacts with the calibration unit, to provide for a calibration procedure by an end operator.

14. The machine tool of claim 12, further comprising:
a checking unit to check a calibration status of the safety unit.

15. The machine tool of claim 14, wherein the checking unit has at least one automatic checking mode.

16. The machine tool of claim 14, wherein the safety unit has a sensor unit for sensing a characteristic quantity during a driving of the tool, and wherein the checking unit, in a checking mode, triggers a sensing operation of the sensor unit prior to the tool being driven.

17. The machine tool of claim 14, further comprising:
a control unit to control a driving of the tool, the control unit, in at least one operating mode, requiring a check of the calibration status to start the tool driving.

18. The machine tool of claim 12, further comprising:
a memory unit; and
a control unit, which, interacts with the memory unit, to store calibration data.

19. The machine tool of claim 12, further comprising:
an output unit; and
a control unit, which, interacts with the output unit, to output information as a function of a calibration status of the safety unit.

20. A method for checking a machine tool, the method comprising:
starting up the machine tool, wherein an end operator starts up the machine tool; and
checking a calibration status of a safety unit of the machine tool, wherein the calibration status of the safety unit is checked after the end operator starts up the machine tool.

21. The method of claim 10, wherein the safety unit is calibrated with the aid of a reference object, which is a machine-tool accessory.

22. A machine tool, comprising:
a safety unit; and
a calibration unit to calibrate the safety unit;
wherein a machine-tool accessory is used to calibrate the safety unit, and
wherein a calibration status of a safety unit of the machine tool is checked after an end operator starts up the machine tool.
